(19) United States
(12) Patent Application Publication
(10) Pub. No.: US 2004/0149086 A1
(43) Pub. Date: Aug. 5, 2004

(54) Attachment for a tool

(76) Inventor: Joseph Thomas Jackson, So. San Francisco, CA (US)

Correspondence Address: Jonathan O. Owens, HAVERSTOCK & OWENS LLP, 162 North Wolfe Road, Sunnyvale, CA, 94086, US

(21) Appl. No.: 10/357,837

(22) Filed: Feb. 3, 2003

(51) Int. Cl. B25D 1/00

(52) U.S. Cl. 81/23

(57) ABSTRACT

A striking adapter configured to be coupled to a tool handle, preferably a hammer handle, having a first end and a second end, the tool handle having a head coupled to the first end, the striking adapter preferably comprising a generally cylindrical body configured to be coupled to the second end, the cylindrical body having an appropriate weight and a striking surface positioned parallel to the second end. The striking surface is substantially flat or curved. The striking surface preferably includes a predetermined gripping pattern and a flanged outer surface located adjacent to the striking surface. The striking adapter includes an aperture for removing an object, such as nail. The striking adapter is coupled to the second end with an adhesive, mechanical attachment means and alternatively form fit.

### FIELD OF THE INVENTION

The invention relates to a hand tool in general, and specifically, to a striking adapter or attachment for a tool, preferably a hammer.

### BACKGROUND OF THE INVENTION

Hammers and other like tools have been widely used in the construction industry as well as for personal use. Hammers and other like tools are typically used in the fashion whereby a head, attached to the top end of the handle, strikes a nail or other object and thereby drives the nail into a surface. The head conventionally includes an anvil for striking the nail at one end and a nail retractor for retracting a hammered nail on the opposite end of the head. Typically, industrial hammers have heavy wooden handles, whereas light, home-use hammers have handles made of steel or other material. In addition to driving nails, hammers are used in stripping forms, hardware, dry-wall and other materials. Many times, these tasks are performed using the bottom end of the hammer handle, especially in driving nails into a ceiling or into a space inaccessible by the hammer head. Although hammers are very durable in driving nails and pulling forms, the bottom end of the wooden hammer handle is not sufficiently robust to withstand the forces applied to it when the bottom end is used in accomplishing the above mentioned tasks. What results is splintering, deterioration and/or breakage in the bottom end of the hammer handle as well as the handle itself.

What is needed is a device which is coupled to the bottom end of the hammer handle or other tool which allows a user to perform at least the above mentioned tasks without damaging the tool.

### SUMMARY OF THE INVENTION

In one aspect of the present invention, a striking adapter that is configured to be coupled to a tool handle which has a first end and a second end. The tool handle has a head coupled to the first end. The striking adapter preferably comprises a generally cylindrical body that is configured to be coupled to the second end. The cylindrical body has an appropriate weight and has a striking surface preferably positioned parallel to the second end. In one embodiment, the striking surface is substantially flat, whereas the striking surface includes a curved surface. The striking surface preferably includes a predetermined gripping pattern and has a flanged outer surface located adjacent to the striking surface. The striking adapter also includes an aperture for removing a nail. The aperture is located in the generally cylindrical body and is proximal to the striking surface. The striking adapter is coupled to the second end with an adhesive or a mechanical attachment means.

In another aspect of the present invention, a hand tool, preferably a hammer, comprising: a handle which has a first end and a second end, a head that is coupled to the first end of the handle and preferably a generally cylindrical striking adapter that is coupled to the second end of the handle. The striking adapter has an appropriate weight and a striking surface that is preferably positioned parallel to the second end. In one embodiment, the striking surface is substantially flat or alternatively curved. The striking surface preferably includes a predetermined gripping pattern and a flanged outer surface that is located adjacent to the striking surface. The striking adapter also includes an aperture for removing a nail. The aperture is located in the generally cylindrical body and is proximal to the striking surface. The striking adapter is coupled to the second end with an adhesive or alternatively with a mechanical attachment means or form fit.

In yet another aspect of the invention, a striking adapter that is configured to be coupled to a tool handle which has a first end and a second end, whereby a head is coupled to the first end. The striking adapter preferably comprises a generally cylindrical body which has an outer surface and an inner cavity, wherein the second end fits within the inner cavity. The striking adapter includes a striking surface that is preferably positioned perpendicular to the outer surface and parallel to the second end. The striking surface preferably includes a predetermined gripping pattern and an aperture for removing a nail, whereby the aperture is located in the outer surface and is proximal to the striking surface. The second end is secured within the inner cavity of the striking adapter with an adhesive, mechanical attachment or form fit. The striking surface of the striking adapter is substantially flat or curved. The outer surface of the striking adapter further comprises a flange feature located adjacent to the striking surface.

### BRIEF DESCRIPTION OF THE DRAWINGS

FIG. 1 illustrates a preferred embodiment of a hammer incorporating a striking adapter in accordance with the present invention.

FIG. 2 illustrates a detailed view of a preferred striking adapter in accordance with the present invention.

FIG. 3 illustrates a detailed view of a preferred striking adapter in accordance with the present invention.

FIG. 4 illustrates a view of the striking surface of the striking adapter with gripping features in accordance with the present invention.

FIG. 5 illustrates a view of an alternative striking adapter with a retracting feature in accordance with the present invention.

FIG. 6 illustrates a view of the alternative striking adapter utilizing the retracting feature in accordance with the present invention.

### DETAILED DESCRIPTION OF THE PRESENT INVENTION

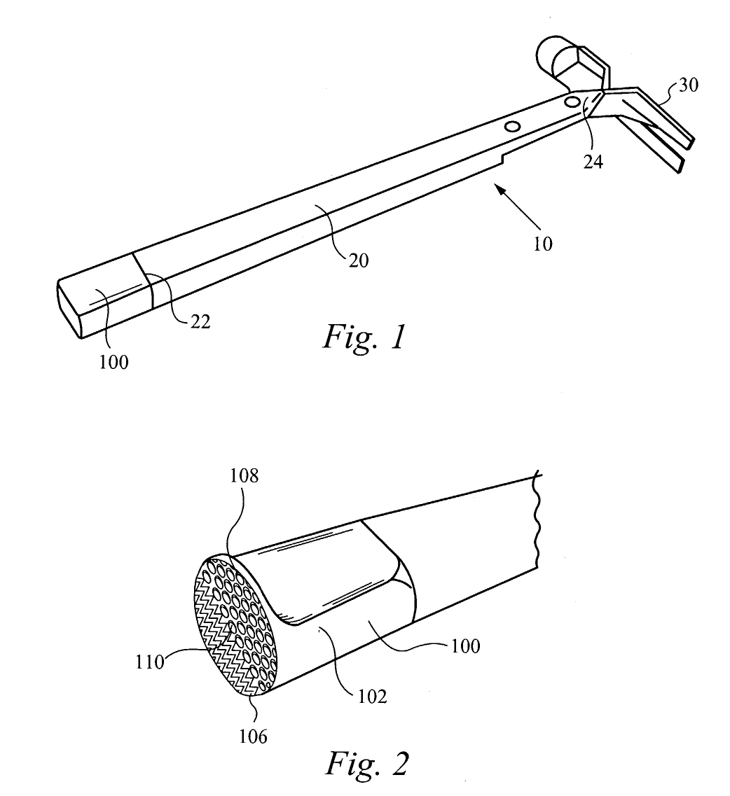

FIG. 1 illustrates a preferred embodiment of a hammer incorporating a striking adapter in accordance with the present invention. The hammer 10 shown in FIG. 1 includes a handle 20, a hammer head 30 and a striking adapter 100. It is apparent to one skilled in the art that although a hammer 10 is shown in FIG. 1 and described throughout, the striking adapter 100 of the present invention is alternatively coupled to any other type of tool, including but not limited to striking tools, such as ball pein hammers, mauls, roofing and brick hammers, mallets, hatchets and sledges. In addition, the present invention is alternatively coupled to tools including, but not limited to, screwdrivers, wrenches, and any type of tool handle. It is also apparent that other additions and features to the hammer 10 are alternatively incorporated and are not limited to the hammer shown in FIG. 1. In particular, the hammer head 30 is coupled to a top end of the handle 10 by conventional methods. The hammer handle 20 has a bottom end, whereby the striking adapter or attachment 100 of the present invention is coupled thereto. The striking adapter 100 is coupled to the handle 20 preferably using an adhesive including, but not limited to, epoxy. Alternatively, the striking adapter 100 is coupled to the handle 20 using a mechanical attachment including, but not limited to, bolts, she-bolts, screws and clamps. Alternatively, the striking adapter 100 is coupled to the handle 20 by doweling or a force fit. Alternatively, the striking adapter 100 is formed with the handle 20 as one piece, whereby the striking adapter 100 is forged onto the bottom end 22 of the handle. It is apparent that the striking adapter 100 may be used with a hammer handle made of any material, and is not limited to handles made of wood or metal.

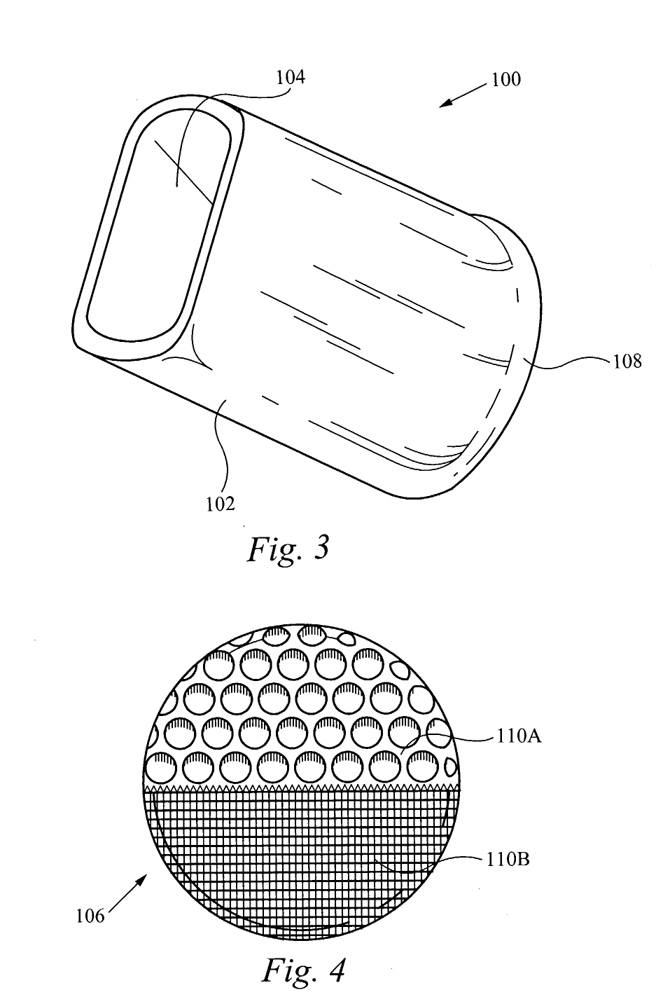

FIGS. 2 and 3 illustrate detailed views of the striking adapter in accordance with the present invention. The striking adapter 100 includes an outer surface configured to fit around the end of the hammer handle 20. The striking adapter 100 preferably includes a cylindrical cavity 104, as shown in FIG. 3, whereby the cavity 104 is configured to receive the bottom end 22 of the handle 20. Alternatively, the cavity 104 has any other appropriate shape including, but not limited to, circular, square and elliptical shapes. The cavity 104 has an inner dimension which receives the bottom end of the handle 20. It is preferred that the bottom end of the handle is not modified to fit securely within the cavity 104. Therefore, the cavity 104 preferably has an inner dimension slightly larger than the bottom end 20 of the handle 20 to allow the handle 20 to securely fit within the cavity 104. The inner dimension of the cavity 104 depends on the width dimension of the handle 20. Alternatively, the cavity 104 has inner dimensions smaller than the bottom end of the handle 20, whereby the bottom end of the handle is thereby modified to fit within the cavity 104.

The striking adapter 104 is preferably made of drawboard steel which is forged and hardened. Alternatively, the striking adapter 104 is made of any other materials including, but not limited to titanium, brass, rubber, copper, iron and stainless steel. It is preferred that the striking adapter 100 be made of the same material as the tool head. Alternatively, the striking adapter 100 is made of a material different than the tool head. The striking adapter 100 has a weight that is dependent on the weight of the hammer 10. For instance, a lighter weight striking adapter would be appropriate for a 20 oz hammer, whereas a heavier weight striking adapter would be appropriate for a 24 oz hammer. The appropriate weight of the striking adapter 100 allows more force to be translated to the striking adapter 100 when striking an object. In addition, the appropriate weight protects the hammer handle 20 as well as the user's hand by better absorbing the shock caused by the impact between the striking surface 106 and the object struck. It should be apparent to those skilled in the art that an appropriately weighted striking adapter 100 can be used with a hammer having any weight.

FIG. 4 illustrates a front view of the striking surface of the striking adapter in accordance with the present invention. As shown in FIGS. 2 and 4, the striking adapter 100 has a striking surface 106 which is at the bottom of the adapter 100 and is preferably parallel to the bottom end of the handle 20. It is preferred that the striking surface 106 is flat, although the striking surface 106 alternatively has a different configuration, including but not limited to curved, slanted and tapered. The striking surface 106 is used to strip or tear down forms, drywall and any hardware, including but not limited to walls, ceilings and any other surface. In addition, the striking surface 106 may be used to loosen tight valve shut-offs as well as hammer in nails which are out of reach or in a location not accessible by the hammer head 30. As shown in FIGS. 2 and 4, the striking surface 106 also preferably includes a gnarled gripping feature 110 which serves to grip the surface that is being struck by the striking surface 106 of the adapter 100. As shown in FIG. 4, the striking surface 106 is preferably divided into two different gripping features 110A, 110B. The features 110A, 110B provide different gripping capabilities, depending on the configuration of the gripping feature. For instance, the feature 110A shown in FIG. 4 is more coarse than the feature 110B and would thereby have a better grip. It is apparent that the gripping feature 110A is not limited to the configurations shown and alternatively encompass other configurations. Such configurations include and are not limited to toothed, sawed, roughened and smooth features. In addition, although only two different gripping features 110 are configured on the striking surface 106 in FIG. 4, it is apparent that any number of gripping features 110 are alternatively configured on the striking surface 106. The gripping features 110 are configured on the striking surface 106 using known methods in the art and will not be discussed in detail herein.

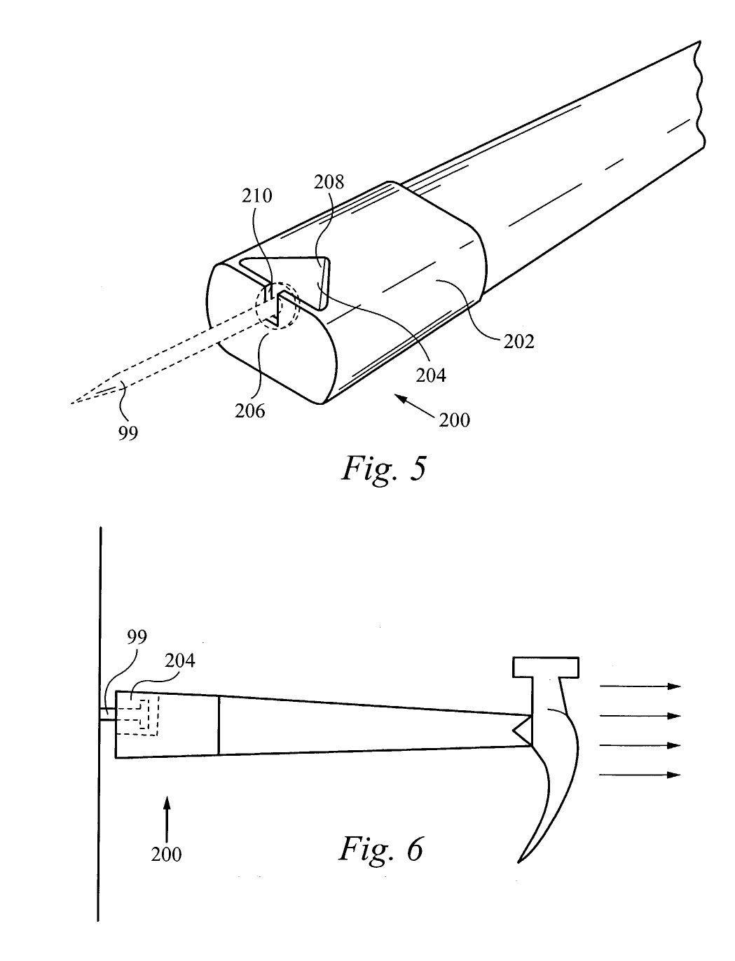

In addition, the striking adapter 100 preferably includes a flange feature 108, as shown in FIG. 3, along the outer surface 102. The flange feature 108 is preferably configured around the outer surface 102 of the adapter 100 and located near the striking surface 106. Alternatively, the striking adapter 100 does not include a flanged feature, as shown in FIG. 5. Although the flanged feature 108 is shown near the striking surface 106, the flanged feature 108 is alternatively located at any other location along the outer surface 102 of the adapter 100. The flanged feature 108 on the outer surface 102 allows the user to apply more force to a surface due to the larger surface area at the striking surface 106. In addition, the flanged feature 108 affords leverage to the user in situations in which the user is at an angle from the striking area. Further, the flanged feature 108 on the outer surface 106 of the striking adapter 100 may be used to pry open forms. The flanged feature 108 on the adapter 100 is created using known methods in the art and will not be discussed in detail herein.

FIG. 5 illustrates a detailed view of an alternative embodiment of the striking adapter in accordance with the present invention. The alternative striking adapter 200 in FIG. 5 has a similar cylindrical shape as in the preferred embodiment. However, the alternative striking adapter 200 in FIG. 5 includes a smooth striking surface 206 and a retracting feature 204 configured along the outer surface 202 of the adapter 200. As shown in FIG. 5, the alternative adapter 200 includes the retracting feature 204 near the striking surface 206, whereby the feature 204 is shown having a triangular shaped cavity 208 within the outer surface 202 of the adapter 200. In addition, the retracting feature 204 includes a slot 210 along the striking surface 206 which is configured to preferably receive the head of a nail 99, as shown in FIG. 5. Alternatively, the slot 210 receives any other object and is thereby not limited to retracting nails. The retracting feature 204 is advantageous in pulling already hammered-nails out of a ceiling or wall. In addition, the retracting feature 204 on the striking adapter 200 at the bottom end 22 allows the user to pull an embedded nail out of a surface by pulling on the hammer, as shown in FIG. 6. The flanged feature 108 on the adapter 100 is created using any known methods in the art, including not limited to extrusion, and will not be discussed in detail herein.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A striking adapter configured to be coupled to a tool handle having a first end and a second end, the tool handle having a tool head coupled to the first end, the striking adapter comprising a body configured to be coupled to the second end, the body having an appropriate weight and a striking surface at the second end.

2. The striking adapter according to claim 1 wherein the tool handle further comprises a hammer handle.

3. The striking adapter according to claim 2 wherein the tool head further comprises a hammer head.

4. The striking adapter according to claim 1 wherein the striking surface is substantially flat.

5. The striking adapter according to claim 1 wherein the body further comprises a generally cylindrical shape.

6. The striking adapter according to claim 1 wherein the striking surface is positioned substantially parallel to the second end.

7. The striking adapter according to claim 1 wherein the striking surface includes a curved surface.

8. The striking adapter according to claim 1 wherein the striking surface includes a predetermined gripping pattern.

9. The striking adapter according to claim 1 further comprising a flanged outer surface located adjacent to the striking surface.

10. The striking adapter according to claim 5 further comprising an aperture for removing an object, the aperture located in the generally cylindrical body and proximal to the striking surface.

11. The striking adapter according to claim 1 wherein the support device is coupled to the second end with an adhesive.

12. The striking adapter according to claim 1 wherein the support device is coupled to the second end with a mechanical attachment means.

13. A tool comprising:
a. a handle having a first end and a second end;
b. a head element coupled to the first end of the handle; and
c. a striking adapter coupled to the second end of the handle, the striking adapter having an appropriate weight and a striking surface at the second end.

14. The tool according to claim 13 wherein the handle further comprises a hammer handle.

15. The tool according to claim 14 wherein the head element further comprises a hammer head.

16. The tool according to claim 13 wherein the striking surface is substantially flat.

17. The tool according to claim 13 wherein the striking surface includes a curved surface.

18. The tool according to claim 13 wherein the striking surface includes a predetermined gripping pattern.

19. The tool according to claim 13 wherein the striking adapter further comprises a flanged outer surface located adjacent to the striking surface.

20. The tool according to claim 13 wherein the body further comprises a generally cylindrical shape.

21. The tool according to claim 20 wherein the striking adapter further comprises an aperture for removing an object, the aperture located in the generally cylindrical body and proximal to the striking surface.

22. The tool according to claim 13 wherein the striking adapter is coupled to the second end with an adhesive.

23. The tool according to claim 13 wherein the striking adapter is coupled to the second end with a mechanical attachment means.

24. The tool according to claim 13 wherein the striking surface is positioned substantially parallel to the second end.

25. A striking adapter configured to be coupled to a tool handle having a first end and a second end, wherein a head member is coupled to the first end, the striking adapter comprising: a body having an outer surface and an inner cavity wherein the second end fits within the inner cavity, the striking adapter including a striking surface at the second end.

26. The striking adapter according to claim 25 wherein the tool handle further comprises a hammer handle.

27. The striking adapter according to claim 26 wherein the head member further comprises a hammer head.

28. The striking adapter according to claim 25 wherein the striking surface includes a predetermined gripping pattern.

29. The striking adapter according to claim 25 further comprising an aperture for removing an object, the aperture located in the outer surface and proximal to the striking surface.

30. The striking adapter according to claim 25 wherein the second end is secured within the inner cavity with an adhesive.

31. The striking adapter according to claim 25 wherein the second end is secured within the inner cavity with a mechanical attachment means.

32. The striking adapter according to claim 25 wherein the striking surface is substantially flat.

33. The striking adapter according to claim 25 wherein the striking surface includes a curved surface.

34. The striking adapter according to claim 25 wherein the outer surface further comprises a flange feature located adjacent to the striking surface.

35. The striking adapter according to claim 25 wherein the body further comprises a generally cylindrical shape.

36. The striking adapter according to claim 25 wherein the striking surface is positioned substantially parallel to the second end.
